(19) United States
(12) Patent Application Publication
(10) Pub. No.: US 2022/0055466 A1
(43) Pub. Date: Feb. 24, 2022

(54) Protective Vehicle Cover Apparatus

(71) Applicant: Robert Sparks, Everett, WA (US)

(72) Inventor: Robert Sparks, Everett, WA (US)

(21) Appl. No.: 16/996,550

(22) Filed: Aug. 18, 2020

(51) Int. Cl. B60J 11/04

(52) U.S. Cl. CPC B60J 11/04

(57) ABSTRACT

A protective vehicle cover apparatus for preventing snow buildup and freezing includes a main cover and a pair of side covers. The main cover comprises a main cover body. The main cover body has a wiper portion, a windshield portion, and a roof portion to cover a vehicle. A plurality of main flaps is coupled to the main cover body. The plurality of main flaps is coupled to a pair of outer edges of the main cover body. A plurality of first fasteners is coupled to the plurality of main flaps. Each side cover comprises a side cover body to cover a window portion of the vehicle. A plurality of second fasteners is coupled to the pair of side covers. The plurality of second fasteners is selectively engageable with the plurality of first fasteners to secure each side cover to the main cover.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vehicle cover devices and more particularly pertains to a new vehicle cover device for preventing snow buildup and freezing.

### (2) Description of Related Art Including Information Disclosed Under 37 CFR 1.97 and 1.98

The prior art relates to vehicle cover devices. Existing devices are typically one piece to cover the entirety of the car of just the windshield. Known devices also lack a flap portion to be secured within the vehicle.

### BRIEF SUMMARY OF THE INVENTION

An embodiment of the disclosure meets the needs presented above by generally comprising a main cover and a pair of side covers. The main cover comprises a main cover body. The main cover body has a wiper portion, a windshield portion, and a roof portion. The wiper portion is configured to cover a pair of windshield wipers of a vehicle, the windshield portion is configured to cover a windshield of the vehicle, and the roof portion is configured to cover a roof of the vehicle. A plurality of main flaps is coupled to the main cover body. The plurality of main flaps is coupled to a pair of outer edges of the main cover body. A plurality of first fasteners is coupled to the plurality of main flaps. Each side cover comprises a side cover body. The side cover body is configured to cover a window portion of the vehicle. The side cover body has an inner side cover face and an outer side cover face. A plurality of second fasteners is coupled to the pair of side covers. The plurality of second fasteners is selectively engageable with the plurality of first fasteners to secure each side cover to the main cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a protective vehicle cover apparatus according to an embodiment of the disclosure.

FIG. 2 is an isometric view of an embodiment of the disclosure.

FIG. 3 is a bottom plan view of an embodiment of the disclosure.

FIG. 4 is a front elevation view of an embodiment of the disclosure.

FIG. 5 is a rear elevation view of an embodiment of the disclosure.

FIG. 6 is an in-use view of an embodiment of the disclosure.

### DETAILED DESCRIPTION OF THE INVENTION

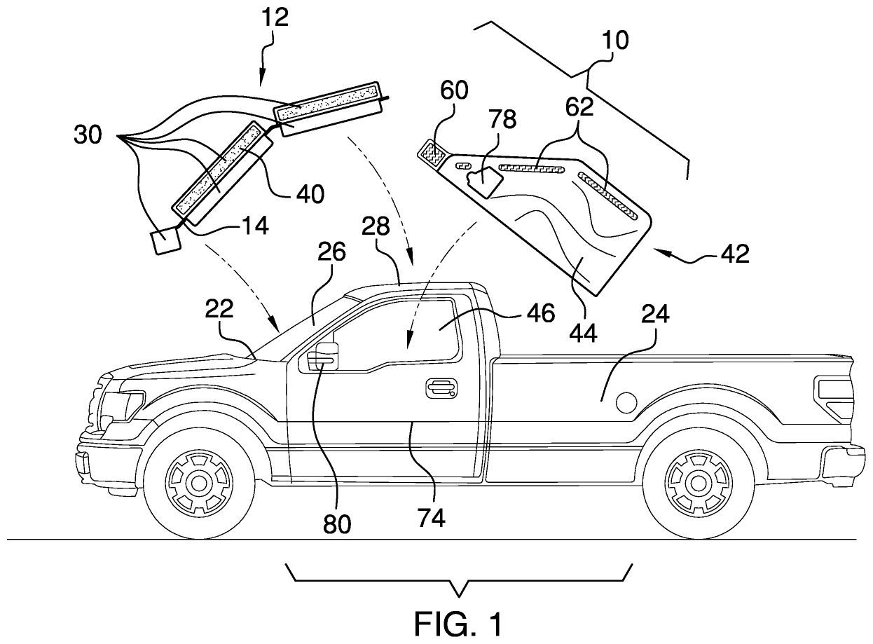

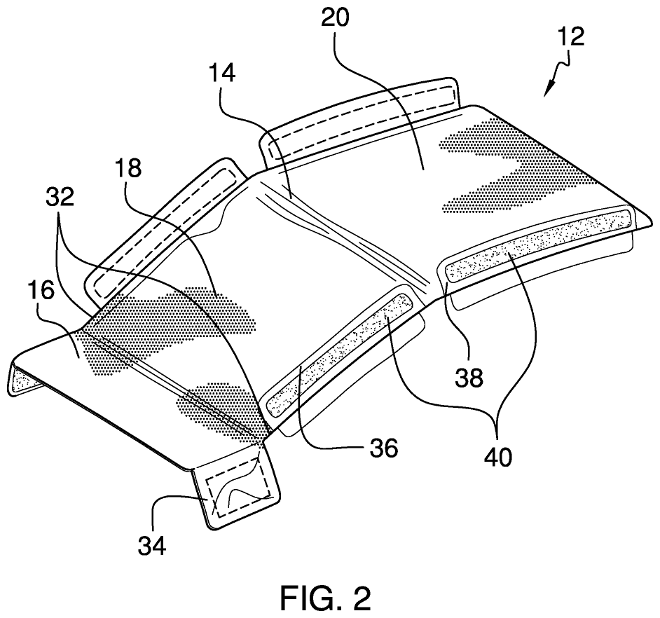

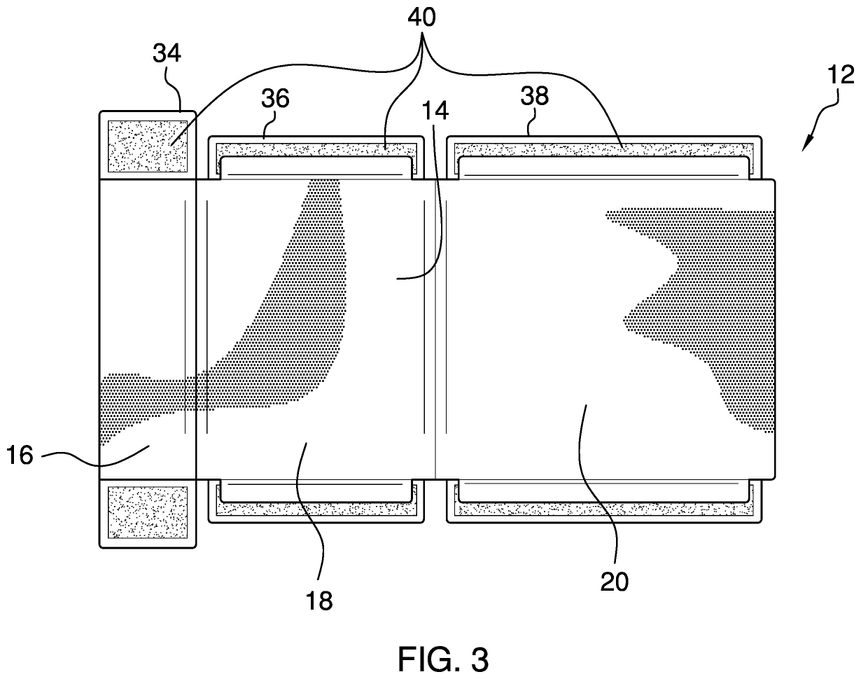

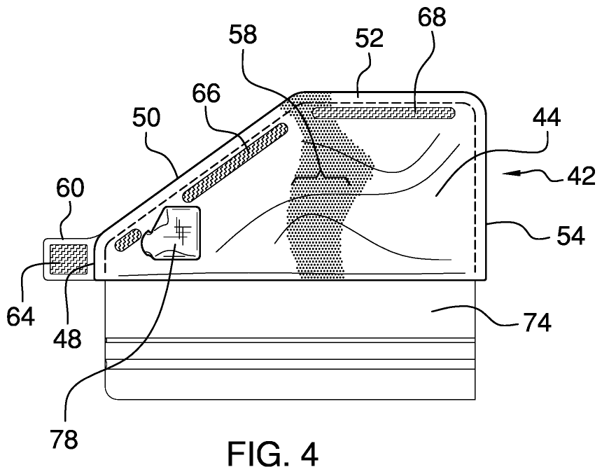

With reference now to the drawings, and in particular to FIGS. 1 through 6 thereof, a new vehicle cover device embodying the principles and concepts of an embodiment of the disclosure and generally designated by the reference numeral 10 will be described.

As best illustrated in FIGS. 1 through 6, the protective vehicle cover apparatus 10 generally comprises a main cover 12 comprising a main cover body 14. The main cover body 14 has a wiper portion 16, a windshield portion 18, and a roof portion 20. The wiper portion 16 is configured to cover a pair of windshield wipers 22 of a vehicle 24, the windshield portion 18 is configured to cover a windshield 26 of the vehicle, and the roof portion 20 is configured to cover a roof 28 of the vehicle. The main cover 12 is substantially flexible to follow the contours of the vehicle 24.

A plurality of main flaps 30 is coupled to the main cover body 14. The plurality of main flaps 30 is coupled to a pair of outer edges 32 of the main cover body. The plurality of main flaps 30 may comprise a wiper flap 34, a windshield flap 36, and a roof flap 38 coupled to each of the outer edges 32 along the wiper portion 16, the windshield portion 18, and the roof portion, respectively. A plurality of first fasteners 40 is coupled to the plurality of main flaps 30.

Each of a pair of side covers 42 comprises a side cover body 44. The side cover body 44 is configured to cover a window portion 46 of the vehicle. The side cover body 44 has a side front edge 48, a side angled edge 50, a side top edge 52, a side back edge 54, an inner side cover face 56, and an outer side cover face 58. There may be a wiper attachment flap 60 coupled to the side front edge 48.

A plurality of second fasteners 62 is coupled to the outer side cover face 58 and the wiper attachment flap 60. The plurality of second fasteners 62 is selectively engageable with the plurality of first fasteners 40 to secure each side cover 42 to the main cover 12. The plurality of second fasteners 62 may include a wiper fastener 64 coupled to the wiper attachment flap 60, a windshield fastener 66 adjacent the side angled edge 50, and a roof fastener 68 adjacent the side top edge 52 to selectively engage the first fasteners 40 of the wiper flap 34, the windshield flap 36, and the roof flap 38, respectively.

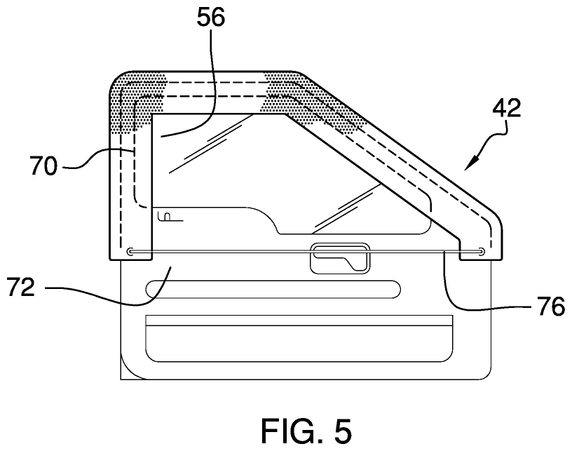

An inner flap 70 is coupled to the side cover body 44. The inner flap 70 may extend from the side front edge 48, the side angled edge 50, the side top edge 52, and the side back edge 54 of the side cover body. The inner flap 70 is configured to extend onto a door inside 72 of a side door 74 of the vehicle as shown in FIG. 5. The side door 74 is then closed to secure the side cover 42 in place.

An elastic strap 76 may be coupled to the inner flap 70. The elastic strap 76 extends from the inner flap 76 proximal the side front edge 48 to the inner flap 76 proximal the side back edge 54 to maintain the side cover 42 in position before closing the side door 74. A mirror pocket 78 may be coupled to the side cover body 44. The mirror pocket 78 is configured to receive a sideview mirror 80 of the vehicle.

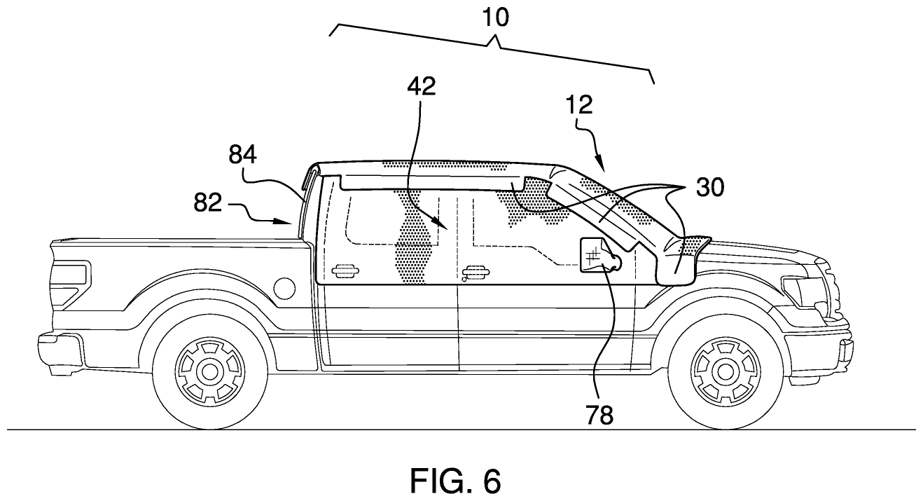

As seen in FIG. 6, there may be a rear window cover 82. The rear window cover 82 comprises a rear window cover body 84 and a third fastener coupled to the rear window cover body 84. The third fastener is selectively engageable with the first fastener 40 coupled to a rear flap 86 of the plurality of main flaps. Each of the first fasteners 40, the second fasteners 62, and the third fastener may be a selectively engageable fastener such as, but not limited to, hook-and-loop fasteners, zippers, or snaps.

In use, the pair of side covers 42 are installed onto the side doors 74 of the vehicle while open and then the side doors 74 are shut. The main cover 12 is then installed and the plurality of first fasteners 40 is engaged with the plurality of second fasteners 62 to maintain it in position. The apparatus 10 is installed during winter to prevent snow and ice buildup on the vehicle 24 for convenience as well as for damage protection.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A protective vehicle cover apparatus comprising:
a main cover comprising:
a main cover body, the main cover body having a wiper portion, a windshield portion, and a roof portion, the wiper portion being configured to cover a pair of windshield wipers of a vehicle, the windshield portion being configured to cover a windshield of the vehicle, and the roof portion being configured to cover a roof of the vehicle;
a plurality of main flaps coupled to the main cover body, the plurality of main flaps being coupled to a pair of outer edges of the main cover body; and
a plurality of first fasteners coupled to the plurality of main flaps; and
a pair of side covers, each side cover comprising:
a side cover body, the side cover body being configured to cover a window portion of the vehicle, the side cover body having an inner side cover face and an outer side cover face; and
a plurality of second fasteners coupled to the pair of side covers, the plurality of second fasteners being selectively engageable with the plurality of first fasteners to secure each side cover to the main cover.

2. The protective vehicle cover apparatus of claim 1 further comprising each side cover having a mirror pocket, the mirror pocket being coupled to the side cover body and being configured to receive a sideview mirror of the vehicle.

3. The protective vehicle cover apparatus of claim 1 further comprising each side cover having an inner flap, the inner flap extending from a side front edge, a side angled edge, a side top edge, and a side back edge of the side cover body, the inner flap being configured to extend onto a door inside of a side door of the vehicle.

4. The protective vehicle cover apparatus of claim 3 further comprising an elastic strap coupled to the inner flap, the elastic strap extending from the inner flap proximal the side front edge to the inner flap proximal the side back edge.

5. The protective vehicle cover apparatus of claim 1 further comprising the plurality of main flaps comprising a wiper flap, a windshield flap, and a roof flap coupled to each of the outer edges.

6. The protective vehicle cover apparatus of claim 5 further comprising the plurality of second fasteners including a wiper fastener, a windshield fastener, and a roof fastener.

7. The protective vehicle cover apparatus of claim 3 further comprising a wiper attachment flap coupled to the side front edge.

8. The protective vehicle cover apparatus of claim 1 further comprising a rear window cover, the rear window cover comprising a rear window cover body and a third fastener coupled to the rear window cover body, the third fastener being selectively engageable with the first fastener coupled to a rear flap of the plurality of main flaps.

9. A protective vehicle cover apparatus comprising:
a main cover comprising:
a main cover body, the main cover body having a wiper portion, a windshield portion, and a roof portion, the wiper portion being configured to cover a pair of windshield wipers of a vehicle, the windshield portion being configured to cover a windshield of the vehicle, and the roof portion being configured to cover a roof of the vehicle;
a plurality of main flaps coupled to the main cover body, the plurality of main flaps being coupled to a pair of outer edges of the main cover body, the plurality of main flaps comprising a wiper flap, a windshield flap, and a roof flap coupled to each of the outer edges; and
a plurality of first fasteners coupled to the plurality of main flaps; and
a pair of side covers, each side cover comprising:
a side cover body, the side cover body being configured to cover a window portion of the vehicle, the side cover body having a side front edge, a side angled edge, a side top edge, a side back edge, an inner side cover face, and an outer side cover face;
a wiper attachment flap coupled to the side cover body, the wiper attachment flap being coupled to the side front edge;
a plurality of second fasteners coupled to the side cover body and the wiper attachment flap, the plurality of second fasteners being selectively engageable with the plurality of first fasteners to secure each side cover to the main cover, the plurality of second fasteners including a wiper fastener, a windshield fastener, and a roof fastener to selectively engage the first fasteners of the wiper flap, the windshield flap, and the roof flap, respectively;
an inner flap coupled to the side cover body, the inner flap extending from the side front edge, the side angled edge, the side top edge, and the side back edge of the side cover body, the inner flap being configured to extend onto a door inside of a side door of the vehicle;
an elastic strap coupled to the inner flap, the elastic strap extending from the inner flap proximal the side front edge to the inner flap proximal the side back edge; and
a mirror pocket coupled to the side cover body, the mirror pocket being configured to receive a sideview mirror of the vehicle.
